(19) United States
(12) Patent Application Publication
(10) Pub. No.: US 2024/0269704 A1
(43) Pub. Date: Aug. 15, 2024

(54) Quick change nozzle system for an atomizer

(71) Applicant: ArcelorMittal, Luxembourg (LU)

(72) Inventors: Carlos Javier RODRIGUEZ MARTINEZ, Gijon, Asturias (ES); Enrique HERRAIZ LALANA, Avilés, Asturias (ES); Mathieu COUVRAT, Montrond les Bains (FR)

(21) Appl. No.: 18/569,350

(22) PCT Filed: Jun. 17, 2021
(86) PCT No.: PCT/IB2021/055362

§ 371 Date: Dec. 12, 2023

(51) Int. Cl. B05B 15/65; B05B 7/06; B22F 9/08

(52) U.S. Cl. CPC B05B 15/65; B05B 7/066; B22F 9/082; B22F 2009/0892

(57) ABSTRACT

A method to quickly change a nozzle assembly suitable for use in a liquid metal atomizing process in which a liquid metal held in a liquid metal reservoir and exiting said metal reservoir through a reservoir opening is atomized by an atomizing fluid to form a metallic spray in an atomizing tower. A sliding nozzle assembly system in which replacement nozzles can be changed on the fly during production. A nozzle assembly designed to be used in conjunction with a support structure. Said nozzle assembly and support structure being designed for use in a nozzle change equipment according.

The present invention relates to the production of metallic powders and in particular to the production of metallic powders by atomization for additive manufacturing. The present invention also relates to the installation for producing the steel powders thereof and particularly focuses on the nozzle used in the atomizing process.

### BACKGROUND

It is known to produce metal powders by atomizing liquid steel. A molten metal is atomized into fine metal droplets by forcing it under pressure through a nozzle, and by impinging it with a jet of fluid, said fluid being either liquid (eg water) or gaseous (eg nitrogen, argon, air or any other suitable gas). The fluid hits the metal stream as it exits the nozzle, creating a turbulence which results in the formation of droplets, which then solidify in the form of metal powder. Said powder is then collected for further treatment.

### SUMMARY OF THE INVENTION

The nozzle is a critical part of the atomizing equipment. Because of the extreme conditions to which it is submitted, it suffers from wear during production and can also be clogged during the process.

The wear and possible clogging of the nozzle is a limiting factor to the length of an atomizing campaign. This leads to productivity and cost issues.

A purpose of the current invention is to address the above-mentioned productivity issue by providing a nozzle assembly designed to be changed without significantly decreasing the atomizing productivity and a method to change a nozzle system during the continuous production of metal powders by atomizing.

The present invention provides for a method to quickly change a nozzle assembly by using a sliding nozzle assembly system and by providing replacement nozzles which can be changed on the fly during production. The present invention further concerns an equipment for implementing the aforementioned method.

The present invention provides a nozzle assembly (10) suitable for use in a liquid metal atomizing process in which a liquid metal (109) held in a liquid metal reservoir (101) and exiting said metal reservoir through a reservoir opening (104) is atomized by an atomizing fluid to form a metallic spray (110) in an atomizing tower (102), said nozzle assembly (10) comprising:
a top part (11), designed to be located closest to the liquid metal reservoir (101) during the atomizing process, said top part having a top face (12),
a bottom part (19), designed to be located closest to the atomizing tower (102) during the atomizing process, said bottom part having a bottom face (18),
an upstream face (14) and a downstream face (15) joining said top and bottom face (12, 18) and being located respectively on the upstream and downstream side of the nozzle assembly when considering a sliding direction S,
a liquid metal nozzle (40) having a liquid metal inlet (41) suitable to be aligned with the reservoir opening (104), and a liquid metal outlet (42) configured to pour out a liquid metal stream in the atomizing tower (102), said liquid metal inlet (41) being located in the top face (12) and said liquid metal outlet (42) being located in the bottom face (18),
an atomizing fluid nozzle (50) having at least one atomizing fluid inlet (51) and an atomizing fluid outlet (52) configured such that a fluid streaming through the atomizing fluid outlet (52) will impinge the liquid metal stream flowing from the liquid metal outlet (42), said atomizing fluid outlet (52) being located in the bottom face (18), wherein said nozzle assembly (10) is adapted to be mounted on a support structure (20) configured such that the nozzle assembly (10) can move within said support structure (20) in a sliding direction S substantially parallel to the liquid metal reservoir opening (104).

### BRIEF DESCRIPTION OF THE DRAWINGS

The invention will now be described in detail and illustrated by examples without introducing limitations, with reference to the appended figure—note that for clarity's sake the atomizing tower is only depicted in FIG. 1 and not in the subsequent figures:

FIG. 1 is a schematic overview of an atomizing device,

FIG. 2 is a front perspective view of the nozzle system change equipment according to an embodiment of the current invention,

FIGS. 3a and 3b are bottom perspective views of the nozzle change equipment according to an embodiment of the current invention—the support structure has no bottom plate on FIG. 3a whereas this bottom plate is present on FIG. 3b,

FIG. 4 is a cross section front perspective view according to axis I-I of FIG. 2 of the nozzle change equipment according to an embodiment of the current invention

FIG. 5 is a top perspective view of a nozzle assembly according to an embodiment of the current invention,

FIG. 6 is a bottom perspective view of a nozzle assembly according to an embodiment of the invention,

FIG. 7 is a cross section according to axis II-II of FIG. 5 of a nozzle assembly according to an embodiment of the invention,

FIG. 8 is a cross section according to axis II-II of FIG. 5 of a nozzle assembly with a top part of a support structure according to an embodiment of the invention.

### DETAILED DESCRIPTION

In the following description and claims, the orientations of the different parts are defined according to the usual direction of a downwards atomizing device, in which the liquid metal reservoir is located above the atomizing chamber and in which the heaviest part of the atomized powder, which are the coarsest, is recovered at the bottom of the atomizing tower by the natural effect of gravity. Hence the directional terms “top”, “up”, “upper”, “above”, “bottom”, “low”, “lower”, “below” etc. should be understood according to said typical configuration of an atomizing device. However, the current invention can be applied regardless of the actual mounted direction of the atomizing device and the directional terms used in the current description and claims should simply be transposed to the directions of the functioning atomizing device. In the attached figures, the top and bottom are indicated respectively by arrows “T” and “B”.

By “substantially parallel” or “substantially perpendicular” it is meant a direction which can deviate from the parallel or perpendicular direction by no more than 15°.

The terms “upstream” and “downstream” refer to the relative position of two elements according to a given direction: the upstream element is located before the downstream element when travelling in the given direction.

The term “encase” refers to a configuration which an element (the encasing element) fully covers or surrounds another element (the encased element).

The term “contiguous” when applied to surfaces defines two surfaces that touch each other at least over a portion of said surfaces. The term “contiguous” when applied to volumes defines two volumes that have contiguous surfaces.

A “refractory” material refers to a material that is resistant to decomposition by heat, pressure, or chemical attack, and retains strength and form at high temperatures.

The terms “high pressure” and “low pressure” refer to the amount of atomizing fluid pressure used in a given atomizing process. The term “high pressure” refers to a pressure level necessary to feed into the atomizing fluid nozzle in order to reach the necessary atomizing fluid pressure exiting the atomizing fluid nozzle. The term “low pressure” refers to a pressure level necessary to feed into the atomizing fluid nozzle in order to reach a positive pressure at the exit of the atomizing fluid nozzle.

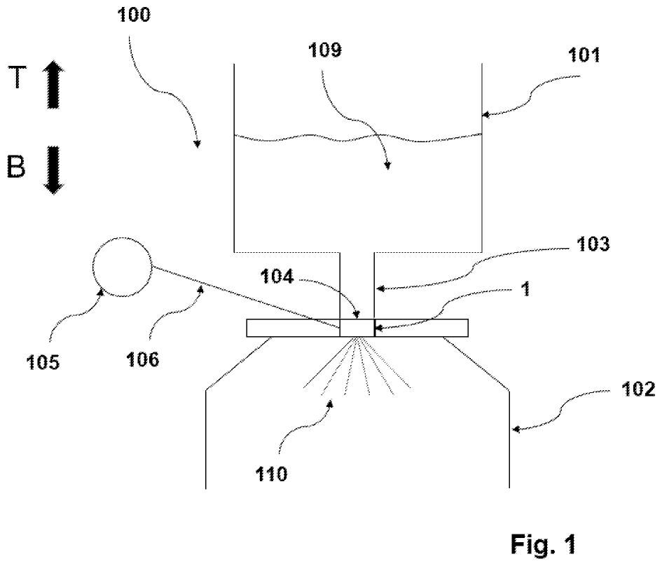

Referring to FIG. 1, a general overview of the atomizing device 100 will first be given.

A molten metal 109, for example steel or aluminum or titanium or any other metal or metal alloy, is atomized into fine metal droplets by forcing it under pressure through a nozzle 1 and by impinging it with a jet of fluid supplied from a fluid supply 105 through a supply circuit 106. The fluid hits the metal stream as it exits the nozzle 1 to enter the atomizing tower 102, creating a turbulence which results in the formation of a spray 110 made of metallic droplets, which then solidify in the form of metal powder. Said powder is then collected for further treatment.

It should be noted that at this stage of the description, the term “nozzle” designates in general the equipment through which the liquid metal enters the atomizing tower. In the subsequent description of the equipment according to the invention, the “nozzle” will be described in more details and will comprise several different parts forming together a “nozzle assembly” as well as a “nozzle change device”.

The molten metal 109 is held in a liquid metal reservoir 101 having a reservoir opening 104 at its bottom, through which the liquid metal can flow into the nozzle 1. For example, the liquid metal reservoir is equipped with a channel 103, through which the liquid metal is forced to exit the reservoir 101 through the reservoir opening 104. This channel 103 can be equipped with an inductor in order to control the liquid metal temperature exiting through the reservoir opening 104.

The atomizing tower 102 is usually filled with inert gas to prevent the powder from oxidizing. The metal droplets cool down during their fall in the atomizing tower.

The atomizing fluid can be liquid or gas. Generally speaking, gas atomization favors the production of powder particles having a high degree of roundness. The particles are also less oxidized than with water atomization for example. On the other hand, liquid atomization and in particular water atomization, can offer a good cost/productivity/quality compromise when the required particle size and shape of the foreseen application allow for it.

In the case of gas atomization, the atomization gas is preferably argon or nitrogen. Helium could also be used but, due to its high thermal conductivity, it requires large superheats (over 300 Celsius) to avoid clogging. They both increase the melt viscosity slower than other gases, e.g. helium, which promotes the formation of smaller particle sizes. They control the purity of the chemistry, avoiding undesired impurities, and play a role in the good morphology of the powder. Finer particles can be obtained with argon than with nitrogen since the molar weight of nitrogen is 14.01 g/mole compared with 39.95 g/mole for argon. On the other hand, the specific heat capacity of nitrogen is 1.04 J/(g K) compared to 0.52 for argon. So, nitrogen increases the cooling rate of the particles. Argon might be preferred over nitrogen to avoid the contamination of the composition by nitrogen and when chemistry of the melt is reactive.

The gas flow impacts the particle size distribution and the microstructure of the metal powder. In particular, the higher the flow, the higher the cooling rate. Consequently, the gas to metal ratio, defined as the ratio between the gas flow rate (in kg/h) and the metal flow rate (in Kg/h), is preferably kept between 1 and 5, more preferably between 1.5 and 3.

The liquid metal nozzle outlet diameter has an impact on the molten metal flow rate and, thus, on the particle size distribution and on the cooling rate. The maximum diameter is for example limited to 6 mm to limit the increase in mean particle size and the decrease in cooling rate. The diameter is more preferably between 2 and 3 mm to more accurately control the particle size distribution and favor the formation of the desired microstructure.

The metal powders obtained by atomization can be classified to keep the particles whose size better fits the technique, notably the additive manufacturing technique, to be used afterwards. For example, in case of additive manufacturing by Powder Bed Fusion, the range 15-50 μm is preferred. In the case of additive manufacturing by Laser Metal Deposition or Direct Metal Deposition, the range 45-150 μm is preferred.

The shape and size of the liquid metal nozzle outlet is critical to ensure a good quality production of metal powder. However, during the atomization process, the nozzle outlet is submitted to important wear coming from the liquid metal pressure weighing upon it, the high temperature imposed by the liquid metal (for example in the case of steel this temperature is upwards of 1500° C.) and from the possible chemical interaction between the material of the liquid metal nozzle and the liquid metal. In order to run a continuous atomization process with a stable product quality level, it will be necessary to change the liquid metal nozzle during the run. Because the atomization process depends on the liquid metal going through the liquid metal nozzle, the nozzle change operation itself will temporarily interrupt the atomization process. For this reason, the operation needs to be performed as fast as possible. Furthermore, because the liquid metal is under pressure to exit by the reservoir opening, it will be necessary to manage the flow of liquid metal during the nozzle change operation for safety and equipment protection purposes (the atomizing tower in particular could be damaged by a liquid metal leak).

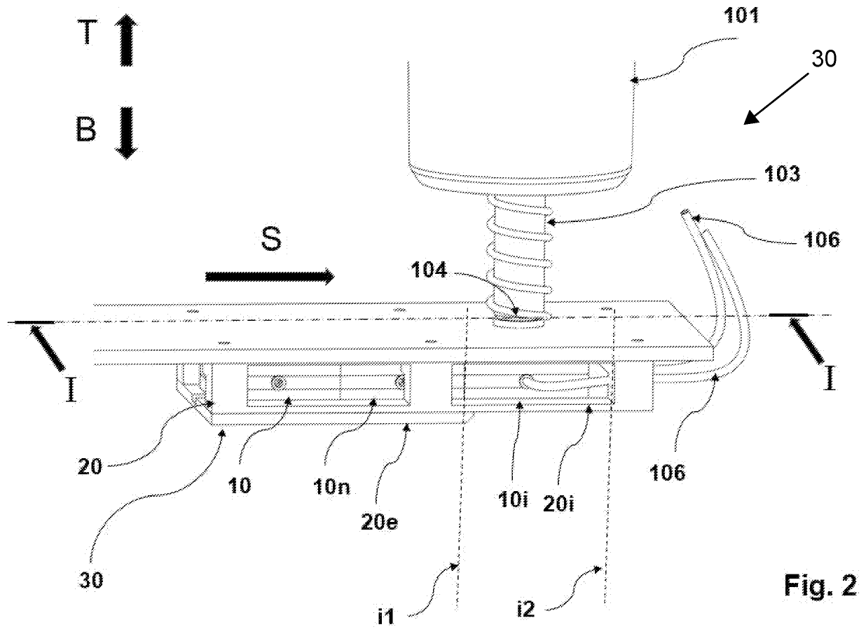

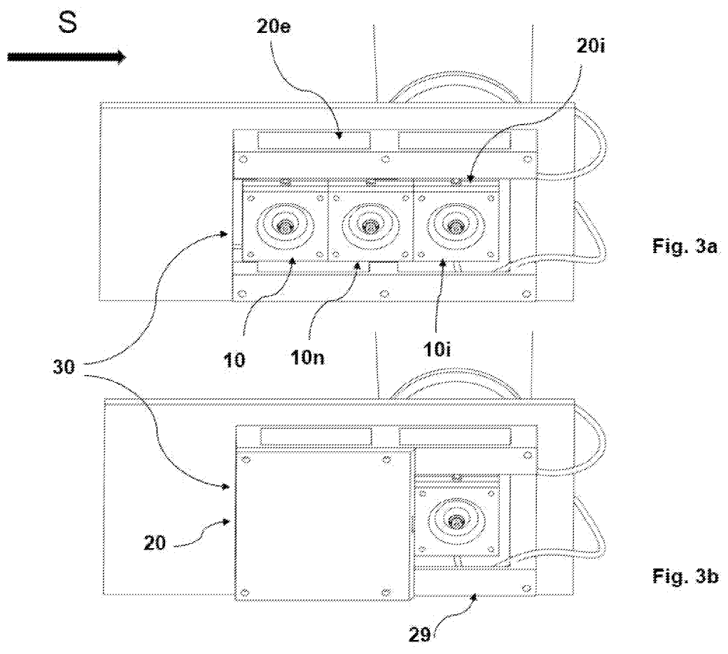

FIGS. 2-4 depict nozzle change equipment 30 according to an embodiment of the current invention. This equipment allows for the nozzle to slide in and out of place in a swift movement for rapid replacement.

The nozzle change equipment 30 comprises the following elements:
at least one nozzle assembly 10,
a support structure 20 intended to hold the nozzle assemblies 10,
a high pressure atomizing fluid supply 105 and distribution circuit 106 (see also FIG. 1), suitable to supply high pressure atomizing fluid for the atomizing process,
a mechanical device designed to move the nozzle assemblies 10 within the support structure in a direction S substantially parallel to the liquid metal reservoir opening 104.

The support structure 20 is configured in such a way that the nozzle assembly 10 can move within said support structure 20 in a direction S substantially parallel to the liquid metal reservoir opening 104, said support structure comprises:
an in-use section 20i corresponding to the portion of the support structure 20 designed to house the nozzle assembly 10i having its liquid metal inlet effectively aligned with the reservoir opening. Referring to FIG. 2, the in-use section is roughly delimited by the dotted lines i1 and i2.
an entry section 20e corresponding to the portion of the support structure 20 located upstream of the in-use section 20i when considering the nozzle assembly movement direction S.

For clarity sake, the sliding direction S in the attached figures is depicted as a straight direction and the general shape of the support structure 20 is a linear straight shape. However, it is also possible to implement the current invention using a curved support structure 20 and an associated curved sliding direction S. Such a curved design can be desirable for example to design a support structure 20 fitting into an allocated volume 20 and more generally to reduce the overall space occupied by the nozzle change equipment 30.

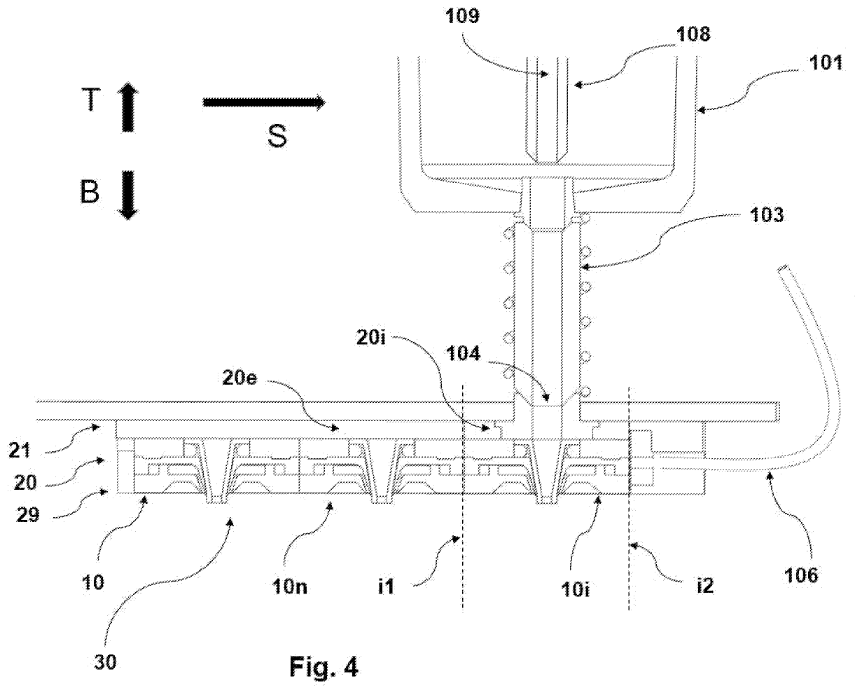

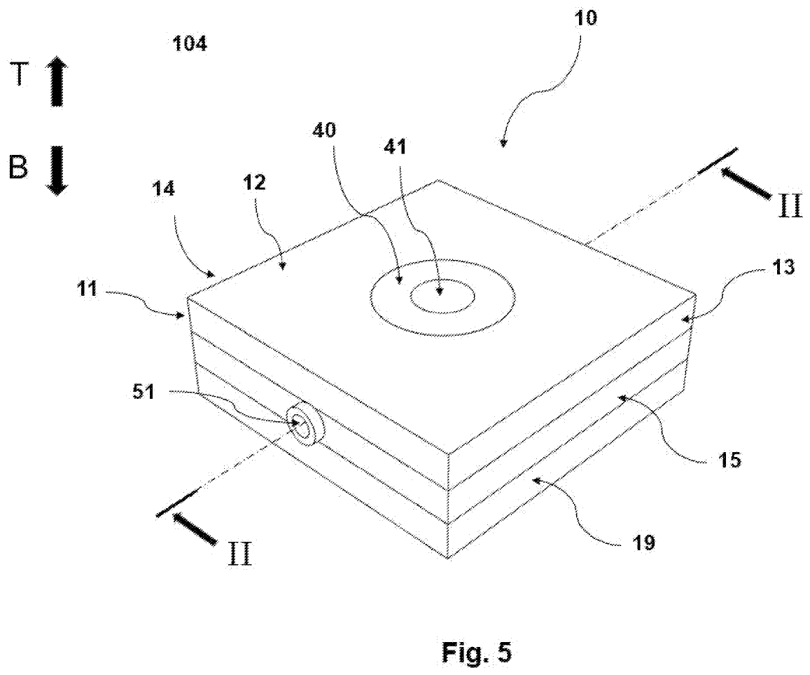

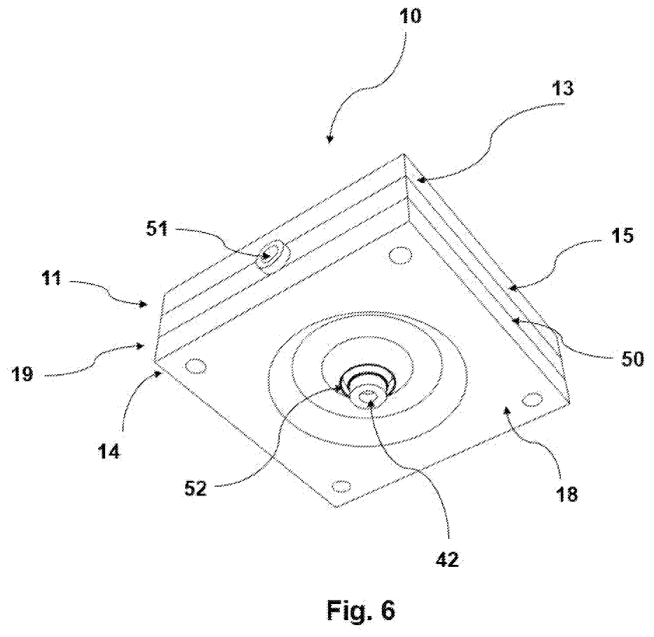

Referring to FIGS. 5 to 8, the nozzle assembly 10 comprises the following elements:
a top part 11, designed to be located closest to the liquid metal reservoir during the atomizing process, said top part having a top face 12,
a bottom part 19, designed to be located closest to the atomizing tower during the atomizing process, said bottom part having a bottom face 18,
an upstream face and a downstream face joining said top and bottom face and being located respectively on the upstream and downstream side of the nozzle assembly when considering a sliding direction S,
a liquid metal nozzle 40 having a liquid metal inlet 41 suitable to be aligned with the reservoir opening 104 (see, e.g, FIG. 4), and a liquid metal outlet 42 configured to pour out a liquid metal stream in the atomizing tower, said liquid metal inlet 41 being located in the top face 12 and said liquid metal outlet 42 being located in the bottom face 18,
an atomizing fluid nozzle 50 having at least one atomizing fluid inlet 51 and an atomizing fluid outlet 52 configured such that a fluid streaming through the atomizing fluid outlet 52 will impinge the liquid metal stream flowing from the liquid metal outlet 42, said atomizing fluid outlet 52 being located in the bottom face 18,
wherein said nozzle assembly 1 is adapted to be mounted on the support structure 20 in a configuration such that the nozzle assembly 1 can move within said support structure 20 in the direction S substantially parallel to the liquid metal reservoir opening 104.

Referring to FIG. 2, in order to change the nozzle assembly 1 during production, a mechanical device pushes the nozzle assemblies 1 so that the in-use nozzle assembly 10i is ejected from the in-use section 20i and replaced by the next in-line nozzle assembly 10n located in the entry section 20e in the position closest to the in-use section 20i. Because this movement can be performed in a very short time, for example in less than 5 seconds or even more preferentially in less than 2 seconds or less than 1 second, the liquid metal flow will be hardly disrupted, and the productivity loss associated to the nozzle change will be very small.

In a particular embodiment, the upstream and downstream faces 14, 15 have complementary shapes ensuring a continuous top face 12 in between two consecutive liquid metal nozzle inlets 41 of two nozzle assemblies 10 having their respective downstream and upstream faces placed against one another.

For clarity sake, the depicted nozzle assemblies 10 in the attached figures all have a generally cubic shape. Their upstream and downstream faces 14, 15 are flat straight surfaces. However, other shapes can be used to implement the current invention. For example, it is possible to use curved surfaces for the upstream and downstream planes, keeping the same curvature radius, in order to ensure the necessary shape complementarity. This type of design can advantageously allow for two successive nozzle assemblies in the support structure to slightly rotate even when pressed one against the other. This in turn can be advantageous when using a support structure having a generally non-linear shape associated to a curved sliding direction S. Advantageously, there will be no detrimental liquid metal leak within the atomizing tower because the above described design of the nozzle assembly 10 ensures that during the nozzle change operation the in-use nozzle assembly 10i and the next in-line nozzle assembly 10n touch each other on their vertical sides so that said nozzle assembly top faces 12 form a continuous surface blocking the metal flow during the nozzle change operation. This means that the nozzle change operation can possibly be performed without the need of a specific equipment, such as a stopper rod, to stop the metal flow. Furthermore, the nozzle change equipment can even be used to purposefully temporarily stop the metal flow in case it is necessary to do so for industrial reasons, such as the need to perform some operations on the atomizing tower or production issues associated within any of the atomizing device's equipment. In order to temporarily stop the metal flow, the in-use nozzle assembly 10i will be pushed partially out of the in-use section 20i and the next in-line nozzle assembly 10n will be pushed partially inside the in-use section so that the reservoir opening is blocked by the top face 12 of either the in-use nozzle assembly 10i, or the next in-line nozzle assembly 10n or both.

In a specific embodiment, such as depicted in FIGS. 5-8, the atomizing fluid inlets 51 of the nozzle change assemblies 10 are located in a different plane than the liquid metal inlets 41. Advantageously, this allows to manage independently the connections to the liquid metal inlet and to the atomizing fluid inlet, which each require good tightness for a smooth atomizing process. In the case of the in-use nozzle 10i, the liquid metal inlet 41 needs to be precisely aligned with the reservoir opening 104. On the other hand, the atomizing fluid inlet 51 needs to be connected in a fluid-tight manner to the atomizing fluid supply 106 (especially so because the atomizing fluid pressure can be very high). If both liquid metal inlets and atomizing fluid inlets are located in the same plane, there is no degree of freedom to adjust their positioning independently and to access them independently. However, if they are located in separate planes, it is possible for example to provide quick fit systems for the atomizing fluid inlets 51, such as depicted in the attached figures. Said atomizing fluid inlets 51 can be accessed easily and independently of the top face 12 of the nozzle assembly.

According to a specific embodiment of the invention, each nozzle assembly 1 has an even number of atomizing fluid inlets 51 forming at least one pair of atomizing fluid inlets and wherein for each said pair, the inlets are located in facing and substantially parallel planes on substantially opposite sides of the nozzle assembly 1. Advantageously, this configuration allows for a better distribution of the atomizing fluid flow within the atomizing fluid nozzle 50.

According to a specific embodiment of the invention, such as depicted on FIG. 5-8, the atomizing fluid outlet 52 is of substantially annular shape. Advantageously, this allows for a homogeneous atomizing fluid flow impinging the liquid metal flow in the atomizing chamber.

According to a specific embodiment of the invention, such as depicted on FIG. 5-8, the top part 11 of each nozzle assembly 10 comprises a top plate 13 made of refractory material and said top plate 13 encases the portion of the liquid metal nozzle 40 located within the top part 11. Advantageously, the use of a refractory material allows for good resistance to the generally high temperatures to which this equipment will be submitted during the atomizing process and also for good resistance to possible liquid metal flow which can impact said top plate 13 either during the nozzle change operation or when using the nozzle change equipment to temporarily stop the liquid metal flow or even as parasite liquid metal leaks. Furthermore, using a design wherein the top plate 13 encases the liquid metal nozzle 40 allows for easy maintenance and assembly of the top part 11, and for good tightness of said top part, which will prevent any damage to the nozzle assembly due to liquid metal leaks during the nozzle change operation, or the use of the nozzle assembly to temporarily stop the metal flow or in general during the atomizing operation.

According to a specific embodiment of the invention, the portion of the top plate 13 comprised in the top face 12 has undergone a surface treatment to reduce its friction coefficient. Advantageously, this allows for the nozzle assemblies 10 to slide smoothly within the support structure 20, minimizing wear both to the nozzle assemblies 10 and to the support structure 20 during the nozzle change operation.

According to a specific embodiment of the invention, the top plate 13 is made of graphite. Graphite being both a refractory material and a low friction coefficient material, this allows to yield the above described advantages of good resistance to liquid metal and general heat of the environment and also of low nozzle assembly and support structure wear during the nozzle change operation.

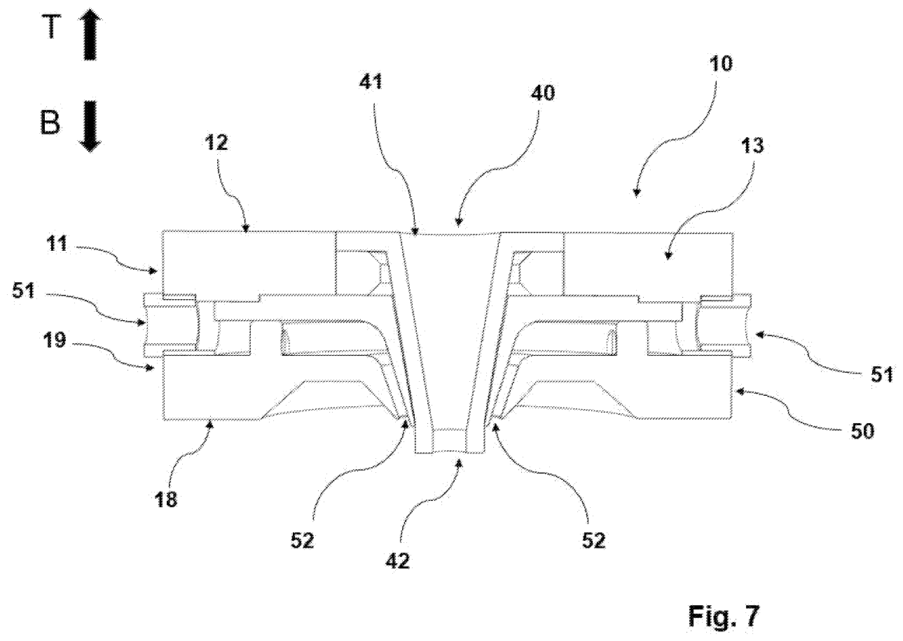

According to a specific embodiment of the invention, such as depicted on FIG. 5-8, the bottom part 19 comprises an atomizing fluid nozzle 50 designed to encase the portion of the liquid metal nozzle 40 located within the bottom part 19. Advantageously, this allows for easy maintenance and assembly of the bottom part 19, and for good tightness of said bottom part. This design also allows to provide for a nozzle assembly wherein the atomizing fluid nozzle 50 can be re-used after the in-use nozzle has been ejected. Indeed, it will be possible to detach the spent liquid metal nozzle 40 from the atomizing fluid nozzle 50, because said liquid metal nozzle has been simply inserted within the provided for encasing volume of the atomizing fluid nozzle 50. This is advantageous in terms of maintenance and operations cost, because the atomizing fluid nozzles are a costly equipment. For example, the atomizing fluid nozzle 50 is made of stainless steel and is provided with quick fit inlets, as previously described. For example, the atomizing fluid nozzle is made of a top and bottom part, which are assembled together, for example by screwing them together, such as depicted on FIG. 7. Advantageously, this allows for a complex part design while still using traditional part manufacturing processes, such as for example casting. This two-part design can also advantageously serve to easily assemble before use and disassemble after use the liquid metal nozzle 40 and the atomizing fluid nozzle 50.

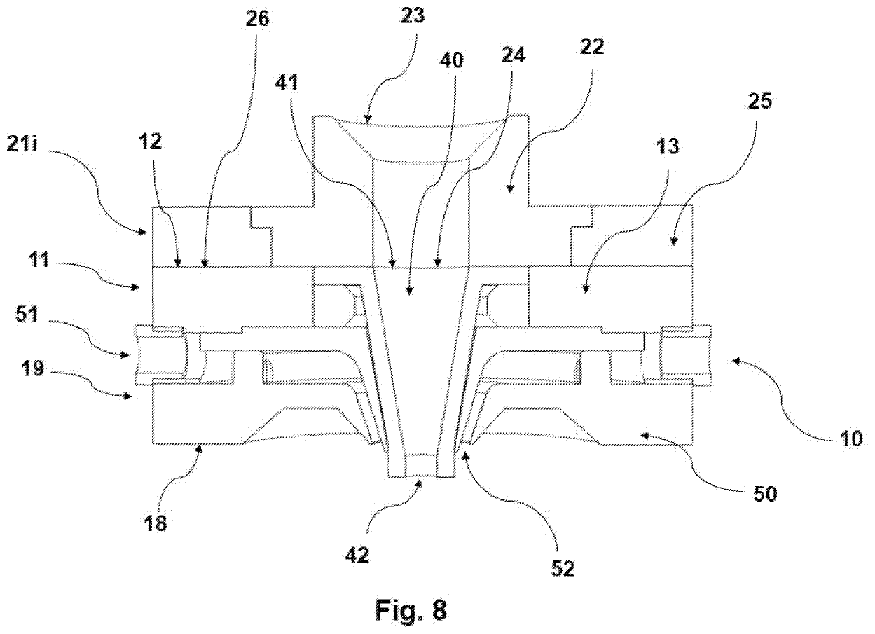

According to a specific embodiment of the invention, as depicted on FIGS. 4 and 8, the support structure 20 comprises a top part 21, designed to be contiguous with the top face 12 of a nozzle assembly 10, wherein the in-use portion of said top part 21i comprises:
an intermediate liquid metal nozzle 22 adapted to be connected on its top side 23 to the reservoir opening 104 and on its bottom side 24 to the in-use nozzle assembly's 10i liquid metal inlet 41.
a top plate 25 encasing said intermediate liquid metal nozzle 22.

In effect, this embodiment allows separation of the nozzle through which the liquid metal flows into two distinct parts: the intermediate nozzle 22, which is a non-moving part integrated within the support structure 20, and the liquid metal nozzle 40 of the nozzle assembly 10, which can easily be changed during the atomizing operation thanks to the above described nozzle change operation. Advantageously, this allows easy changing of the most critical part of the nozzle, which is the liquid metal outlet 42, while avoiding contact between the moving part of the nozzle and the reservoir opening 104, which would lead to wear of said reservoir opening and associated parts of the liquid metal reservoir 101, such as for example the channel 103. Furthermore, providing a top plate 25 encasing the intermediate liquid metal nozzle 22 makes it possible to extract and replace the intermediate liquid metal nozzle 22 after the atomizing run is finished and ensures good tightness and stability of the equipment.

According to a specific embodiment of the invention, the support structure in-use section's top plate 25 is made of refractory material. Advantageously, this allows for good resistance to the generally high temperatures to which this equipment will be submitted during the atomizing process and also for good resistance to possible liquid metal flow resulting from parasite liquid metal leaks.

According to a specific embodiment of the invention, the bottom face 26 of the portion of the support structure in-use section's top plate 25 has undergone a surface treatment to reduce its friction coefficient. Advantageously, this allows for the nozzle assemblies 10 to slide smoothly within the support structure 20 in the in-use section 20i, minimizing wear both to the nozzle assemblies 10 and to the support structure 20 during the nozzle change operation.

According to a specific embodiment of the invention, the support structure's in-use section's top plate 25 is made of graphite. Graphite being both a refractory material and a low friction coefficient material, this allows to yield the above described advantages of good resistance to liquid metal and general heat of the environment and also of low nozzle assembly and support structure wear during the nozzle change operation.

According to a specific embodiment of the invention, such as depicted on FIG. 2-4, the support structure 20 further comprises a bottom part 29, adapted to support the bottom part 19 of a nozzle assembly 10. Advantageously, this allows for better mechanical stability of the nozzle change device, since the nozzle assemblies are supported from the bottom.

According to a specific embodiment of the invention, the nozzle change equipment 30 further comprises a low pressure fluid supply and distribution circuit (not depicted in the attached figures), wherein:
at least the next in-line nozzle assembly 10n has at least one of its atomizing fluid supply inlet connected to said low pressure fluid supply,
the in-use nozzle assembly 10i has at least one of its atomizing fluid supply inlet connected to the high pressure atomizing fluid supply.

By connecting the next-in line nozzle assembly 10n to a low-pressure fluid circuit, a positive pressure will be ensured at the atomizing fluid outlet 52 of said next in-line nozzle assembly 10n. Advantageously, this will protect the atomizing fluid outlet 52 and the atomizing fluid nozzle 50 in general, from pollution by stray metallic powder particles that could be present in the atomizing tower. Indeed, it is known that very small diameter metallic particles, such as for example metallic particles having a diameter less than 5 micrometers, will fly around in the atomizing tower, and will not easily be captured by the appropriate equipment of the atomizing tower. These stray particles can clog and damage the atomizing fluid nozzle, compromising its good functioning when it is in the in-use position and also making it more difficult to re-use it in subsequent runs without cleaning or maintenance. The use of a low pressure fluid to prevent metallic powder pollution advantageously makes use of the existing fluid inlets 52, avoids wasting costly high pressure fluid for this purpose and also ensures that there is no negative interaction between the fluid exiting from the next in-line nozzle assembly 10n and the high pressure fluid exiting from the in-use nozzle assembly 10i.

According to a specific embodiment of the invention, the fluid used in the low pressure fluid supply and distribution circuit is the same fluid as the atomizing fluid. Advantageously, this makes optimal use of the existing fluid inlet 52 and fluid circulation chambers of the atomizing fluid nozzle 50. Indeed, these are configured for the flow of the atomizing fluid.

According to a specific embodiment of the invention, the low pressure fluid supply comprises at least a portion of recirculated atomizing fluid recovered after being decompressed through use in the atomizing process. Advantageously, using the available spent atomizing fluid can yield costs and efficiency benefits.

According to a specific embodiment of the invention, at least the in-use nozzle assembly 10i and the next in-line nozzle assembly 10n are connected both to the high pressure and the low pressure circuits and the nozzle change equipment 30 further comprises a valve system for each nozzle assembly in order to switch between the low pressure and the high pressure circuits for each nozzle assembly. Advantageously, this allows to implement the above described low pressure fluid blowing system to prevent metallic powder contamination without having to manage fluid supply connections when performing a nozzle change operation—the fluid supply of the new in-use nozzle 10i will be switched to the high pressure fluid supply during the nozzle change operation by operating the valve system.

According to a specific embodiment of the invention, the nozzle change equipment 30 further comprises a linear actuator designed to switch the fluid supply to a nozzle assembly fluid inlet 51 between the high pressure circuit and the low pressure circuit. Advantageously, this allows to use the same set of fluid inlet 51 both for the connection to the high pressure and the low pressure fluid supply, thereby simplifying the design and maintenance of the atomizing fluid nozzle 50.

According to a specific embodiment of the invention, the nozzle change equipment 30 further comprises a liquid metal nozzle wear detector, not depicted on the attached figures, configured to monitor the level of material wear of the in-use liquid metal nozzle outlet. Advantageously, this allows to perform the nozzle change operation at the optimal time, thereby guaranteeing maximum efficient use of the in-use nozzle assembly without deteriorating the quality and productivity of the atomizing process.

According to a specific embodiment of the invention, as depicted on FIG. 4, the nozzle change equipment 30 further comprises a stopper rod 108 designed to block the liquid metal flow exiting through the reservoir opening 104. For example, the stopper rod is moved downwards to block the entry of the channel 103 in order to stop the liquid metal flow. Advantageously, the presence of a stopper rod ensures the possibility to stop the metal flow when necessary, for example for operation reasons or in order to change the nozzle. This allows to further prevent any liquid metal leak during the nozzle change operation.

According to a specific embodiment of the invention, as depicted on FIG. 4, said stopper rod 108 houses a hollow volume 109 and further comprises a rod opening 110, through which a pressure can be applied on the liquid metal below the stopper rod in order to push out the liquid metal remaining below the stopper rod through the liquid metal outlet 42 when the stopper rod 108 is used to stop the liquid metal flow. Indeed, when operating the stopper rod to stop the liquid metal flow, the portion of liquid metal comprised within the liquid metal nozzle 40 will not anymore be submitted to the pressure coming from the liquid metal in the liquid metal reservoir. As a consequence, this will stop the liquid metal from flowing through the liquid metal nozzle 40 and this will possibly lead to freezing of the metal within the liquid metal nozzle 40, making it impossible to use it again once the stopper rod is lifted. Furthermore, the liquid metal column could further solidify upwards of the liquid metal nozzle 40 (for example within the intermediate nozzle 22 or within the reservoir opening 104). This will create a solid connection of solidified metal between the nozzle assembly 10 and the support structure or even the liquid metal reservoir, which will block the sliding movement of the nozzle assembly 10, and thus effectively block the overall functioning of the nozzle change equipment 30. In order to prevent this, it is advantageous to use the above described hollow stopper rod 108 with a rod opening 110 through a pressure can be applied on the liquid metal below the stopper rod in order to push out the liquid metal remaining below the stopper rod through the liquid metal outlet 42 when the stopper rod 108 is used to stop the liquid metal flow. For example, a fluid can be blown through the rod opening 110 to apply pressure on the liquid metal column beneath the stopper rod, in order to eject it and prevent the above described detrimental solidification. For example, the stopper rod can further comprise an inner rod able to slide downwards within the hollow volume 109 thus compressing the fluid within the hollow volume 109 to apply the necessary pressure to push out the remaining liquid metal below the stopper rod.

According to a specific embodiment of the invention, an upward pressure is applied to the bottom part 19 of the in-use nozzle assembly 10i during the atomizing process, said upward pressure being configured to counteract the downward pressure resulting from the liquid metal flow. Advantageously, this allows to make sure that the in-use nozzle assembly 10i will be held firmly in place during the atomizing process and will not move due to parasite shear stresses or vibrations etc. Furthermore, this will also protect the support structure. Indeed, the downward pressure exerted by the liquid metal flow through the liquid metal nozzle 20 results in a downward pressure exerted by the in-use nozzle assembly 10i on the support structure 20. If this pressure is not compensated by purposefully applying an invert upward pressure, the entire load of said pressure will be borne by the support structure 20, which can result in mechanical wear, warping, deformation and ensuing maintenance issues. Such considerations are all the more critical considering that the atomizing operation generates high temperatures and that the support structure will therefore be submitted to both high temperatures and high mechanical loads, which can result in premature failure due to well known phenomena such as creep.

The nozzle change operation implementing the above described equipment comprises the following steps:
A/ providing a nozzle change equipment as previously described,
B/ operating the mechanical device in order to activate the movement of the nozzle assemblies in the sliding direction S
C/ pushing the in-use nozzle assembly out of the in-use section of the support structure and replacing it by the next in-line nozzle, which becomes the new in-use nozzle

The nozzle change operation optionally comprises an additional step of switching the fluid supply to the new in-use nozzle from the low pressure fluid supply to the high pressure atomizing fluid supply. Said step being performed by using a valve system, or a linear actuator or any other system suitable to perform a rapid switch between said high and low pressure fluid supplies.

The nozzle change operation optionally comprises an additional step of using the information a liquid metal nozzle wear detector configured to monitor the level of material wear of the in-use liquid metal nozzle outlet in order to determine the suitable moment at which to operation the nozzle change operation.

The nozzle change operation optionally comprises an additional step of moving a stopper rod in order to stop the liquid metal flow from the reservoir opening 104 before the above described step B.

The nozzle change operation optionally comprises an additional step of applying a pressure on the liquid metal below the stopper rod in order to push out the liquid metal remaining below the stopper rod through the liquid metal outlet 42 before the above described step B.

The nozzle change operation optionally comprises an additional step of applying an upward pressure on the bottom part of the in-use nozzle assembly after the above described step C.

What is claimed is:

15. 1-15 (canceled)

16. A nozzle assembly suitable for use in a liquid metal atomizing process, a liquid metal being held in a liquid metal reservoir and exiting the metal reservoir through a reservoir opening to be atomized by an atomizing fluid to form a metallic spray in an atomizing tower, the nozzle assembly comprising:
a top part, designed to be located closest to the liquid metal reservoir during the atomizing process, the top part having a top face;
a bottom part, designed to be located closest to the atomizing tower during the atomizing process, the bottom part having a bottom face;
an upstream face and a downstream face joining the top face and the bottom face and being located respectively on an upstream side and a downstream side of the nozzle assembly with respect to a sliding direction;
a liquid metal nozzle having a liquid metal inlet suitable to be aligned with the reservoir opening, and a liquid metal outlet configured to pour out a liquid metal stream in the atomizing tower, the liquid metal inlet being located in the top face and the liquid metal outlet being located in the bottom face;
an atomizing fluid nozzle having at least one atomizing fluid inlet and an atomizing fluid outlet configured such that a fluid streaming through the atomizing fluid outlet will impinge the liquid metal stream flowing from the liquid metal outlet, the atomizing fluid outlet being located in the bottom face;
wherein said nozzle assembly is adapted to be mounted on a support structure configured such that the nozzle assembly is moveable within said support structure in the sliding direction, the sliding direction being substantially parallel to the liquid metal reservoir opening.

17. The nozzle assembly as recited in claim 16 wherein the upstream and downstream faces have complementary shapes ensuring a continuous top face in between the liquid metal inlet and a consecutive liquid metal inlet of a further nozzle assembly having respective downstream and upstream faces placed against one another.

18. The nozzle assembly as recited in claim 16 wherein the at least one atomizing fluid inlet is located in a different plane than the liquid metal inlet.

19. The nozzle assembly as recited in claim 16 wherein the at least one atomizing fluid inlet includes an even number of atomizing fluid inlets forming at least one pair of atomizing fluid inlets and wherein for each said pair, the atomizing fluid inlets are located in facing and substantially parallel planes on substantially opposite sides of the nozzle assembly.

20. The nozzle assembly as recited in claim 16 wherein the atomizing fluid outlet is of substantially annular shape.

21. The nozzle assembly as recited in claim 16 wherein the top part includes a top plate made of refractory material, the top plate being designed to encase the portion of the liquid metal nozzle located within the top part.

22. The nozzle assembly as recited in claim 21 wherein a portion of the top plate at the top face has undergone a surface treatment to reduce a friction coefficient.

23. The nozzle assembly as recited in claim 21 wherein the top plate is made of graphite.

24. The nozzle assembly as recited in claim 16 wherein the bottom part includes an atomizing fluid nozzle designed to encase the portion of the liquid metal nozzle located within the bottom part.

25. A support structure designed to hold at least one nozzle assembly as recited in claim 16, the support structure configured in such a way that the nozzle assembly is movable in the support structure in the sliding direction, the support structure comprising:
an in-use housing section corresponding to a portion of the support structure designed to house an in-use nozzle assembly, wherein the in-use nozzle assembly has a liquid metal inlet effectively aligned with the reservoir opening; and
an entry housing section corresponding to an upstream portion of the support structure located upstream of the in-use section with respect to the sliding direction.

26. The support structure as recited in claim 25 further comprising a top part, designed to be contiguous with a top face of a nozzle assembly, wherein an in-use portion of the top part comprises:
an intermediate liquid metal nozzle adapted to be connected on a top side to the reservoir opening and on a bottom side to the liquid metal inlet of the in-use nozzle assembly; and
a top plate encasing the intermediate liquid metal nozzle.

27. The support structure as recited in claim 26 wherein the top plate is made of refractory material.

28. The support structure as recited in claim 26 wherein a bottom face of the top plate has undergone a surface treatment to reduce a friction coefficient.

29. The support structure as recited in claim 26 wherein the top plate is made of graphite.

30. The support structure as recited in claim 26 further comprising a support structure bottom part, adapted to support the bottom part of a nozzle assembly.
